(19) United States
(12) Patent Application Publication
(10) Pub. No.: US 2024/0244170 A1
(43) Pub. Date: Jul. 18, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: TAISUKE NISHIO, Kanagawa (JP)

(21) Appl. No.: 18/406,986

(22) Filed: Jan. 8, 2024

(30) Foreign Application Priority Data
Jan. 12, 2023 (JP) 2023-003146

(51) Int. Cl. H04N 9/73

(52) U.S. Cl. CPC H04N 9/73

(57) ABSTRACT

In an image processing apparatus, a shift of black balance in an input image is detected, at least one of information regarding white balance to be applied to the input image or information regarding static black balance is acquired, the shift of the black balance is corrected based on at least one of the information regarding the white balance or the information regarding the static black balance in a case in which the shift of the black balance is detected, and the shift of the black balance is adjusted in accordance with the calculated correction value.

### BACKGROUND

### Field

The present disclosure relates to image processing and, more particularly, to an image processing apparatus, an image processing method, a storage medium, and the like.

### Description of the Related Art

In the related art, imaging devices that perform white balance (WB) control in accordance with light sources in imaging environments and output color images are known. Furthermore, imaging devices that correct black balance (BB) in accordance with characteristics of imaging sensors are known.

For example, Japanese Patent Application Laid-Open No. 2007-208884discloses a technique for storing table data in which a luminance signal and an offset value of a color difference signal are associated with each other, and determining an offset value of the color difference signal in accordance with the luminance signal.

On the other hand, input/output characteristics of an imaging sensor may change due to influences such as temperature and changes with the elapse of time, in addition to individual variations, sensitivity (sensor gain) characteristics, and the like, and black balance may be shifted when the input/output characteristics of the imaging sensor change. When the black balance is shifted, coloring that does not inherently exist may occur in a captured image, resulting in a problem that color reproducibility of a subject deteriorates.

### SUMMARY

An image processing apparatus according to some embodiments includes at least one processor and a memory coupled to the at least one processor, the memory storing instructions that, when executed by the at least one processor, cause the at least one processor to detect a shift of black balance in an input image, acquire at least one of information regarding white balance to be applied to the input image or information regarding static black balance, calculate a correction value for correcting the shift of the black balance based on at least one of the information regarding the white balance or the information regarding the static black balance in a case in which the shift of the black balance is detected, and adjust the shift of the black balance in accordance with the calculated correction value.

Further features of the present disclosure will become apparent from the following description of embodiments with reference to the attached drawings.

### BRIEF DESCRIPTION OF THE DRAWINGS

FIG. 1 is a functional block diagram illustrating an example of a functional configuration of an image processing apparatus according to a first embodiment.

FIG. 2 is a diagram illustrating an example of a look up table (LUT) of an offset amount for each of R, G, and B according to the first embodiment.

FIG. 3 is a diagram illustrating an example of an effective range of a white balance gain according to the first embodiment.

FIG. 4 is a flowchart showing an example of an image processing method for calculating a BB offset of the image processing apparatus according to the first embodiment.

FIGS. 5A to 5C are diagrams illustrating an example of control of a black balance correction value (offset) when WB is shifted to a G side in the first embodiment.

FIGS. 6A to 6C are diagrams illustrating an example of control of a black balance correction value (offset) when WB is shifted to R and B sides in the first embodiment.

FIG. 7 is a functional block diagram illustrating an example of a functional configuration of an image processing apparatus according to a second embodiment.

FIGS. 8A to 8C are diagrams illustrating an example of control of a black balance correction value (offset) when infrared light is not taken in in the second embodiment.

FIGS. 9A to 9C are diagrams illustrating an example of control of a black balance correction value (offset) when infrared light is taken in in the second embodiment.

FIG. 10 is a functional block diagram illustrating an example of a functional configuration of an image processing apparatus according to a third embodiment.

FIGS. 11A to 11C are diagrams illustrating an example of black balance control when WB is shifted to a G side in the third embodiment.

FIGS. 12A to 12C are diagrams illustrating an example of black balance control when WB is shifted to R and B sides in the third embodiment.

FIG. 13 is a functional block diagram illustrating an example of a functional configuration of an image processing apparatus according to a fourth embodiment.

FIGS. 14A to 14C are diagrams illustrating an example of black balance control according to the fourth embodiment.

FIG. 15 is a functional block diagram illustrating an example of a functional configuration of an image processing apparatus according to a fifth embodiment.

FIG. 16 is a diagram illustrating an example of an LUT of an offset amount for each of R, G, and B according to the fifth embodiment.

FIGS. 17A to 17C are diagrams illustrating an example of black balance control according to the fifth embodiment.

FIG. 18 is a functional block diagram illustrating an example of a functional configuration of an image processing apparatus according to a sixth embodiment.

FIG. 19 is a diagram illustrating an example of an LUT according to the sixth embodiment.

FIG. 20 is a diagram illustrating an example of a hardware configuration of an image processing apparatus according to the present disclosure.

### DESCRIPTION OF THE EMBODIMENTS

Hereinafter, with reference to the accompanying drawings, favorable modes of the present disclosure will be described according to some embodiments. In each diagram, the same reference signs are applied to the same members or elements, and duplicate description will be omitted or simplified.

### First Embodiment

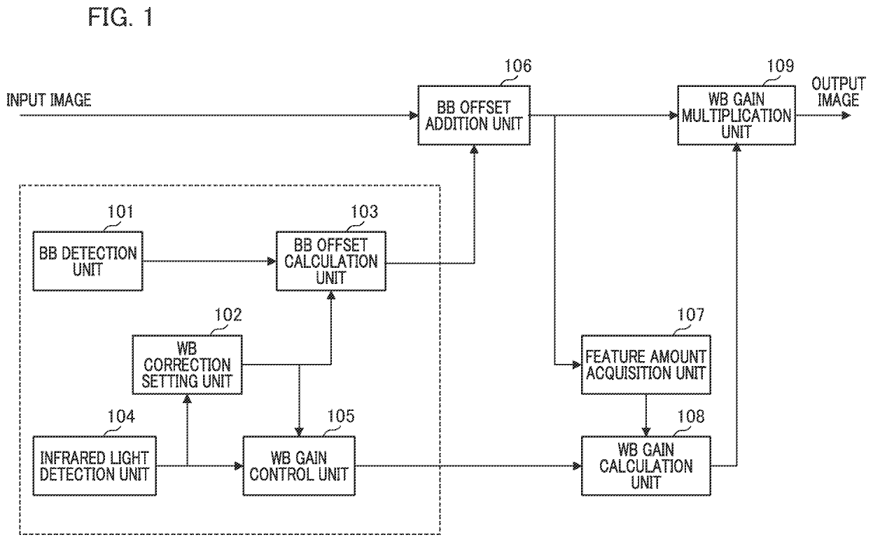

Hereinafter, an image processing apparatus according to a first embodiment of the present disclosure will be described with reference to FIG. 1. FIG. 1 is a functional block diagram illustrating an example of a functional configuration of the image processing apparatus according to the first embodiment. Some of functional blocks illustrated in FIG. 1 are realized by causing a central processing unit (CPU) or the like as a computer included in the image processing apparatus to execute a computer program stored in a memory as a storage medium.

However, some or all of them may be realized by hardware. As the hardware, a dedicated circuit (ASIC), a processor (reconfigurable processor, DSP, or the like), circuitry, or combinations thereof, can be used.

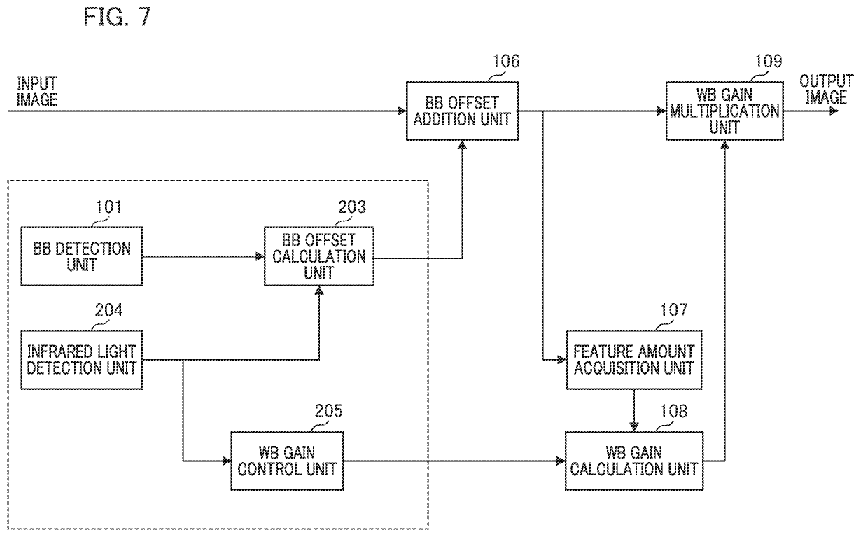

Further, the respective functional blocks illustrated in FIG. 1 do not need to be built into the same housing, and may be constituted by separate devices connected to each other via signal paths. The above description regarding FIG. 1 also applies to FIGS. 7, 10, 13, 15, and 18.

An input image is captured by an imaging unit constituted by a lens and an imaging sensor (imaging element), which are not illustrated in the drawing. Further, the input image is image data, which is constituted by a plurality of pixels, or an image signal, and includes a plurality of pieces of color information. The plurality of colors are, for example, red (R), green (G), and blue (B) colors, and the image data (signal) is equivalent to the amount of light that passes through color filters corresponding to the respective colors provided on the imaging sensor, which is not illustrated in the drawing, and is then converted into an electrical signal by the imaging sensor.

Color filters transmit not only visible light corresponding to red, green, and blue colors, but also some infrared light (invisible light). For this reason, in general imaging devices, an infra-red cut-off filter (IRCF) is provided to remove an infrared light component, thereby making it possible to obtain images close to those of human vision.

An output image is an image in which black balance (BB) is appropriately corrected by adding an offset value to a pixel value of each color of the input image, and white balance is appropriately corrected by multiplying it by a white balance gain (WB gain).

Examples of the white balance gain include a Red gain that adjusts redness of an output image and a Blue gain that adjusts blueness of an output image. There are offset values for respective colors of R, G, and B.

In the first embodiment, in a configuration in which an offset is added to an input image and then multiplied by a white balance gain, an offset amount for correcting black balance is determined based on a shift amount of black balance and a shift amount of white balance. Furthermore, in the first embodiment, when infrared light is taken in and imaged, white balance can be intentionally shifted in accordance with a setting value.

A BB detection unit (detection unit) 101 detects (detects) a shift amount of black balance (BB), and outputs the shift amount of black balance to a BB offset calculation unit 103.

The larger a gain (sensor gain) multiplied by an output signal of the sensor, the greater a shift amount of black balance, and thus the shift amount of black balance is associated with the sensor gain in the first embodiment. That is, for example, the BB detection unit 101 outputs the value of the sensor gain to the BB offset calculation unit 103 as the shift amount of black balance. The value of the gain is represented by, for example, a decibel (dB) value.

A WB correction setting unit 102 sets a shift amount of white balance (WB) in accordance with a detection result of an infrared light detection unit 104.

The shift amount of white balance is represented by, for example, a value from 0 to 10 (WB correction setting) that can be set by a user. The smaller the value, the greater a shift amount to a magenta (Mg) side, and the larger the value, the greater a shift amount to a G side.

Further, when the color of the input image is affected by infrared light, the WB correction setting unit 102 outputs the set shift amount of white balance to the BB offset calculation unit 103 and a WB gain control unit 105 based on the detection result acquired from the infrared light detection unit 104.

When the color of the input image is not affected by infrared light, the set shift amount of white balance is not output to the BB offset calculation unit 103 and the WB gain control unit 105, and information indicating that there is no white balance shift is output.

The BB offset calculation unit 103 acquires a shift amount of black balance from the BB detection unit 101. Further, the BB offset calculation unit 103 acquires a shift amount of white balance from the WB correction setting unit 102, calculates offset amounts for R, G, and B, and outputs the calculated offset amounts to a BB offset addition unit 106. Here, the BB offset calculation unit 103 calculates a correction value for correcting a shift of black balance.

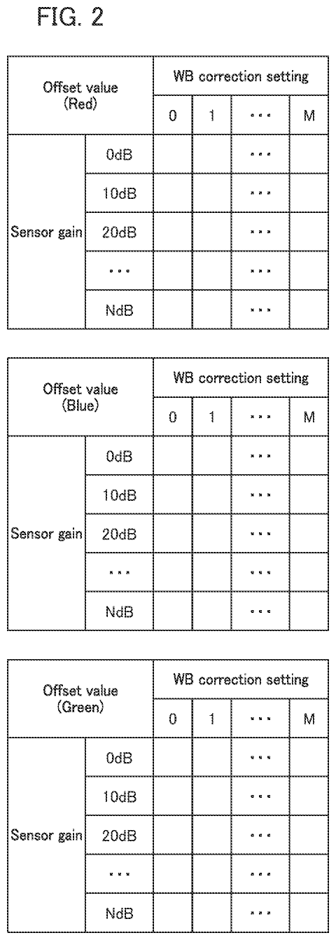

FIG. 2 is a diagram illustrating an example of an offset amount LUT for each of R, G, and B according to the first embodiment. The offset amount for each of R, G, and B may be determined with reference to, for example, a look-up table (LUT) in which a sensor gain (shift amount of black balance) and WB correction setting (shift amount of white balance) as illustrated in FIG. 2 are associated with each other. In FIG. 2, M represents a maximum value of a WB correction setting value, and N represents a maximum value of a sensor gain.

Then infrared light detection unit (determination unit) 104 determines whether the color of an input image captured by the imaging sensor is affected by infrared light, and outputs a detection result to the WB correction setting unit 102 and the WB gain control unit 105.

For example, when an IRCF, which is not illustrated in the drawing, is inserted on the optical axis of the lens of the imaging unit, the infrared light detection unit 104 detects that the color of the input image is not affected by infrared light. On the other hand, when the IRCF is not inserted on the optical axis of the lens of the imaging unit (removed from the optical axis), the infrared light detection unit 104 detects that the color of the input image is affected by the infrared light.

The WB gain control unit 105 acquires a shift amount of white balance from the WB correction setting unit 102 and a detection result from the infrared light detection unit 104, determines parameters for calculating a white balance gain, and outputs the parameters to the WB gain calculation unit 108. The parameters for calculating the white balance gain include, for example, parameters for determining an effective range of the white balance gain.

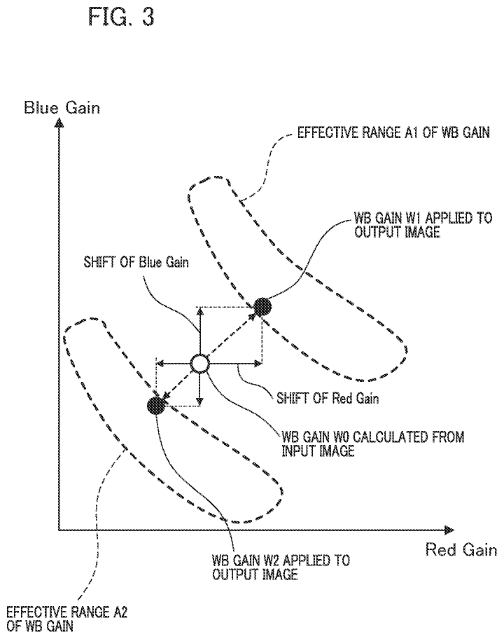

FIG. 3 is a diagram illustrating an example of an effective range of a white balance gain according to the first embodiment. The effective range of the white balance gain is determined such that, for example, when there is an influence of infrared light on an input image, the larger a shift amount of white balance to a Mg side, the larger the values of a Red gain and a Blue gain can be (for example, A1 in FIG. 3).

On the other hand, the effective range of the white balance gain is determined such that, when there is an influence of infrared light on the input image, the larger the shift amount of white balance to a G side, the smaller the values of the Red gain and the Blue gain can be (for example, A2 in FIG. 3).

The BB offset addition unit 106 acquires offset amounts for R, G, and B from the BB offset calculation unit 103, adds the offset amounts to the input image, and outputs the offset-added image to a feature amount acquisition unit 107 and a WB gain multiplication unit 109.

The feature amount acquisition unit 107 acquires the offset-added image from the BB offset addition unit 106, calculates a feature amount regarding color, and outputs the feature amount to the WB gain calculation unit 108. More specifically, when an image is divided into a plurality of rectangular regions, color information for each rectangular region determined by image data included in each rectangular region is calculated. The color information is, for example, a representative value such as an average value or a most frequent value of a color difference signal for each rectangular region.

The WB gain calculation unit 108 acquires color information for each region from the feature amount acquisition unit 107 based on the parameters for determining the effective range of the white balance gain from the WB gain control unit 105 to calculate a white balance gain (WB gain), and outputs the calculated white balance gain to the WB gain multiplication unit 109.

More specifically, the WB gain calculation unit 108 calculates a first white balance gain (for example, W0 in FIG. 3) such that the representative value of the color information for each region acquired by the feature amount acquisition unit 107 becomes a predetermined target value.

Furthermore, the WB gain calculation unit 108 determines an effective range of a white balance gain based on parameter for determining the effective range of the white balance gain. Then, the WB gain calculation unit 108 outputs the first white balance gain to the WB gain multiplication unit 109 when the first white balance gain is included in the effective range of the white balance gain.

On the other hand, when the first white balance gain is not included in the effective range of the white balance gain, the WB gain calculation unit 108 outputs a second white balance gain (for example, W1 and W2 in FIG. 3), which is obtained by modifying the first white balance gain, to the WB gain multiplication unit 109. The second white balance gain is, for example, a white balance gain that is included in the effective range of the white balance gain and is closest to the first white balance gain.

The WB gain multiplication unit 109 multiplies the offset-added image supplied from the BB offset addition unit 106 by the WB gain obtained from the WB gain calculation unit 108 to generate and output an output image.

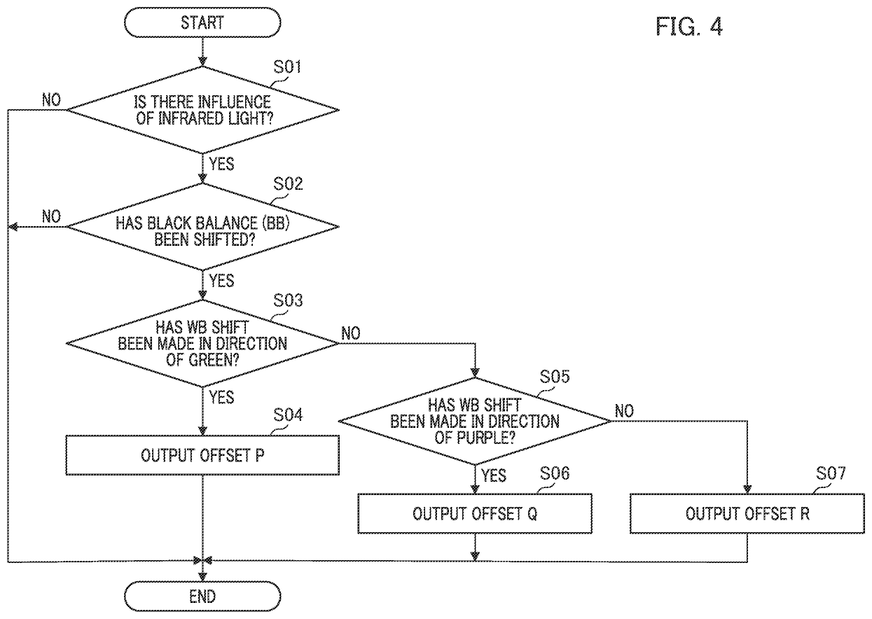

An example of a method of calculating a BB offset of the image processing apparatus according to the first embodiment will be described with reference to FIG. 4. FIG. 4 is a flowchart showing an example of an image processing method for calculating a BB offset of the image processing apparatus according to the first embodiment.

In step S01, the infrared light detection unit 104 acquires (detects) whether the color of an input image captured by the imaging sensor is affected by infrared light as information regarding white balance.

Step S01 functions as an acquisition step (acquisition unit) of acquiring the information regarding white balance to be applied to the input image, and also functions as a determination step (determination unit) of determining whether the input image is affected by infrared light. When it is detected that the color of the input image is affected by infrared light, the processing proceeds to step S02, and when it is detected that the color of the input image is not affected by infrared light, the processing in FIG. 4 is terminated.

In step S02 (detection step), the BB detection unit 101 detects whether black balance has been shifted. When it is detected that the black balance has been shifted, the processing proceeds to step S03, and when it is detected that the black balance has not been shifted, the processing in FIG. 4 is terminated.

In step S03, the WB correction setting unit 102 detects whether white balance has been shifted in the direction of green (G). When it is detected that the white balance has been shifted in the direction of green, the processing proceeds to step S04, and when it is detected that white balance has not been shifted in the direction of green, the processing proceeds to step S05.

In step S04, the BB offset calculation unit 103 outputs an offset value P suitable for a case where the white balance has been shifted in the direction of green, and the processing in FIG. 4 is terminated.

In step S05, the WB correction setting unit 102 detects whether white balance has been shifted in the direction of purple (Mg). When it is detected that the white balance has been shifted in the direction of purple, the processing proceeds to step S06, and when it is detected that the white balance has not been shifted in the direction of purple, the processing proceeds to step S07.

In step S06, the BB offset calculation unit 103 outputs an offset value Q suitable for a case where the white balance has been shifted in the direction of purple, and the processing in FIG. 4 is terminated.

In step S07, the BB offset calculation unit 103 outputs an offset value R suitable for a case where the white balance has not been shifted, and the processing in FIG. 4 is terminated. Here, step S04, step S06, and step S07 function as calculation steps of calculating a correction value for correcting a shift of black balance.

According to the offset value (correction value) calculated by the BB offset calculation unit 103, the BB offset addition unit (adjustment unit) 106 executes an adjustment step of adjusting a shift of black balance.

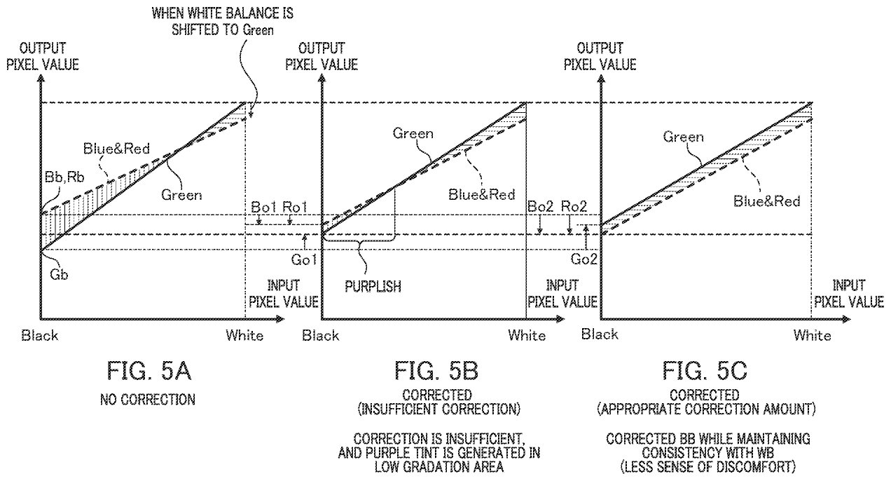

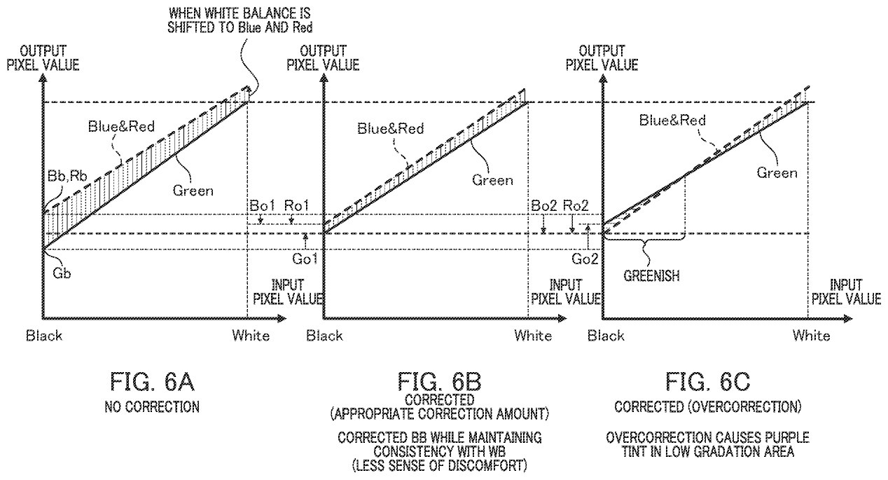

Effects of the first embodiment will be described below. FIGS. 5A to 5C are diagrams illustrating an example of control of a black balance correction value (offset) when WB is shifted to a G side in the first embodiment. FIGS. 6A to 6C are diagrams illustrating an example of control of a black balance correction value (offset) when WB is shifted to R and B sides in the first embodiment.

FIGS. 5A to 5C and FIGS. 6A to 6C illustrate an example of characteristics of a pixel value of an input image and a pixel value of an output image when subjects of achromatic colors ranging from black (Black) to white (White) are imaged. FIGS. 5A and 6A illustrate an example of a case when black balance has not been corrected, and FIGS. 5B, 6B, 5C, and 6C illustrate an example of a case where black balance has been corrected.

Offset amounts in FIGS. 5B and 6B are different from those in FIGS. 5C and 6C, but the offset amount in FIG. 5B and the offset amount in FIG. 6B are equal to each other, and the offset amount in FIG. 5C and the offset amount in FIG. 6C are equal to each other. B offsets in FIGS. 5B and 6(B) are represented by Bo1, R offsets are represented by Ro1, and G offsets are represented by Go1.

On the other hand, B offsets in FIGS. 5C and 6C are represented by Bo2, R offsets are represented by Ro2, and G offsets are represented by Go2. The magnitude of each of the offset amounts is represented by the length of an arrow, an upward arrow represents a positive offset (addition) and a downward arrow represents a negative offset (subtraction). Further, when there is no arrow, it indicates “no offset (0)”.

In FIGS. 5B and 6B, the offset amounts are smaller than those in FIGS. 5C and 6C, and black balance is corrected more weakly. On the other hand, in FIGS. 5C and 6C, the offset amounts are larger than those in FIGS. 5B and 6B, and black balance is corrected more strongly. Further, for the sake of simplicity, the characteristics of R and B are made the same, and only G is made different.

In the case of no correction in FIG. 5A, it is indicated that an output pixel value in Black is larger for Blue and Red than for Green, and the black balance is shifted to Mg. Such a phenomenon is more likely to occur as a sensor gain is larger, and the larger the sensor gain is, the larger the shift amount of black balance becomes.

On the other hand, it is indicated that an output pixel value in White is larger for Green than for Blue and Red, and the white balance is shifted to G based on a setting value of the WB correction setting unit 102. That is, this is a case where the white balance and the black balance are shifted in opposite directions.

In the case of no correction in FIG. 6A, it is indicated that an output pixel value in Black is larger for Blue and Red than for Green, and the black balance is shifted to Mg.

On the other hand, it is indicated that an output pixel value in White is larger for Blue and Red than for Green, and the white balance is shifted to Mg based on a setting value of the WB correction setting unit 102. That is, the white balance and the black balance are shifted in the same direction.

In the case of FIG. 5B, it is indicated that, even after black balance has been corrected, an output pixel value in Black is slightly larger for Blue and Red than for Green, and the black balance is shifted to a Mg side. In this case, since shifts to different color sides occur in White and Black, the shift of the black balance is conspicuous.

On the other hand, in the case of FIG. 6B, although the offset amounts are the same as those in FIG. 5B, the black balance is shifted to a Mg side in both White and Black, and thus the shift of the black balance is inconspicuous. Similarly, in the case of FIG. 5C, since the black balance is shifted to a G side in both White and Black after the black balance has been corrected, the shift of the black balance is inconspicuous.

On the other hand, in the case of FIG. 6C, the white balance is shifted to Mg, the black balance is shifted to G, and shifts to different color sides occur in White and Black, and thus the shift of the black balance is conspicuous.

From the above, when shifts to different color sides occur in White and Black before black balance is corrected, the shift of the black balance is conspicuous in the case of insufficient correction. On the other hand, when shifts to the same color side occur in White and Black before black balance is corrected, the shift of the black balance is conspicuous in the case of overcorrection.

Consequently, in the first embodiment, when shifts to different color sides occur in White and Black, an offset amount is set to be larger, whereas an offset amount is set to be smaller when shifts to the same color side occur in White and Black. That is, in the case of FIG. 5A, black balance is corrected with the offset amount as illustrated in FIG. 5C, and in the case of FIG. 6A, black balance is corrected with the offset amount as illustrated in FIG. 6B.

That is, in the black balance correction in the first embodiment, the BB offset calculation unit 103 determines an offset amount with reference to a shift amount of black balance and a shift amount of white balance. For this reason, an appropriate offset amount can be applied depending on how white balance is shifted.

Then, an offset amount is set to be larger when shifts to different color sides occur in White and Black, and an offset amount is set to be smaller when shifts to the same color side occur in White and Black, thereby achieving black balance correction suitable for white balance.

In the first embodiment, a shift amount of black balance is associated with the magnitude of a sensor gain, but the present disclosure is not limited thereto. For example, a shift amount of black balance may be associated with, for example, a shutter speed, a sensor temperature, an iris aperture value, an environmental temperature, an operating time of the imaging device, or the like.

That is, the shift amount of black balance may be associated with at least one of a sensor gain, a shutter speed (charge accumulation time), a sensor temperature, an aperture value, an environmental temperature, and an operating time of the imaging device.

The black balance is more likely to be shifted as an imaging environment is in lower illumination. In the case of imaging in a low illumination environment, a shutter speed (or a charge accumulation time) generally tends to become slow (or long) and an aperture tends to open in order to secure brightness of an image. Thus, it can be estimated that the slower (longer) the shutter speed (charge accumulation time) is, or the closer an iris aperture value is to an open value (the smaller the aperture value), the lower the illuminance of the imaging environment, and the greater a shift of black balance.

Additionally, the higher the temperature around the sensor, the greater the shift of the black balance due to an increase in a dark current. Alternatively, the longer the operating time (power-on time) of the imaging device and the imaging sensor, the higher the temperature around the sensor, and the black balance is shifted more. Furthermore, the longer the operating time of the imaging device and the imaging sensor, the more the imaging sensor deteriorates, results in an increase in a dark current and a greater shift of the black balance.

Further, for example, semiconductor devices generally tend to deteriorate more rapidly as the temperature increases, and in this case, a shift amount of black balance increases due to a combination of the temperature and the operating time. Thus, it is desirable that a plurality of parameters among the above-described various parameters for estimating a shift of black balance be used in combination.

In the first embodiment, a shift amount of white balance is a WB correction setting value that is set by the WB correction setting unit 102, but the present disclosure is not limited thereto. The shift amount of white balance may be, for example, a difference between the first white balance gain and the second white balance gain which was calculated by the WB gain calculation unit 108 in the past (for example, one frame before).

Alternatively, the shift amount of white balance may be a white balance gain itself. The larger the white balance gain (Red gain and Blue gain), the more the white balance is shifted to a magenta side, and the smaller the white balance gain, the more the white balance is shifted to a Green side.

Furthermore, the shift amount of white balance may be a difference between whether imaging is performed with the IRCF inserted or whether imaging is performed with the IRCF removed. For example, a difference in the color of a captured image in a case where a white subject is imaged with the same white balance gain between when the IRCF is inserted and when the IRCF is removed is a shift amount of white balance.

In general, when the IRCF is removed, white balance is shifted in a reddish manner compared to when the IRCF is inserted. Alternatively, a color correction amount for suppressing a difference in color between when the IRCF is inserted and when the IRCF is removed may be used as a shift amount of white balance.

For example, when a color correction amount is small, a reddish tinge of an image will remain when the IRCF is removed, and thus a shift amount of white balance is large. As the color correction amount increases, the redness of the image when the IRCF is removed is reduced, and thus the shift amount of white balance becomes smaller.

In the first embodiment, an offset amount of black balance correction is changed depending on how white balance is shifted, but the present disclosure is not limited thereto. An offset amount of black balance correction may be changed depending on a correction amount of white balance.

For example, when imaging is performed by removing the IRCF, the color of a captured image is shifted in the direction of magenta compared to when the IRCF is inserted, but it is possible to reduce this color shift in the captured image by correcting white balance.

At this time, an offset amount of black balance correction is changed in accordance with a correction amount of white balance. More specifically, when the correction amount of white balance is small, the captured image when the IRCF is removed is shifted to magenta, and even when black balance is shifted to the magenta side, there is little sense of discomfort, and thus absolute values of offset subtraction amounts for Blue and Red are reduced. Alternatively, an absolute value of an offset addition amount for Green is reduced.

Then, as the correction amount of white balance increases, a color shift in the captured image when the IRCF is removed decreases, and a shift of black balance becomes more conspicuous, and thus absolute values of offset subtraction amounts for Blue and Red are increased. Alternatively, an absolute value of an offset addition amount for Green is increased.

### Second Embodiment

Hereinafter, an image processing apparatus according to a second embodiment of the present disclosure will be described with reference to FIG. 7.

In the second embodiment, in a configuration in which an offset is added to an input image and then multiplied by a white balance gain, an offset amount for correcting black balance is determined based on a shift amount of black balance and whether there is an influence of infrared light. Furthermore, in the second embodiment, even when infrared light is taken in and imaged, white balance can be maintained appropriately.

FIG. 7 is a functional block diagram illustrating an example of a functional configuration of the image processing apparatus according to the second embodiment. The same functional blocks as those in the first embodiment are denoted by the same reference numerals, and the descriptions thereof will be omitted.

A BB offset calculation unit 203 acquires a shift amount of black balance from a BB detection unit 101 and a detection result of the influence of infrared light from an infrared light detection unit 204, calculates offset amounts for R, G, and B, and outputs the calculated offset amounts to a BB offset addition unit 106.

The infrared light detection unit 204 detects whether the color of an input image captured by an imaging sensor is affected by infrared light, and outputs the detection result to the BB offset calculation unit 203 and a WB gain control unit 205.

The WB gain control unit 205 acquires the detection result from the infrared light detection unit 204, determines parameters for calculating a white balance gain, and outputs the parameters to a WB gain calculation unit 108. The parameters for calculating the white balance gain include, for example, parameters for determining an effective range of the white balance gain.

The effective range of the white balance gain is determined such that, for example, when there is an influence of infrared light on an input image, a Red gain and a Blue gain can have smaller values than when there is no influence of infrared light.

When there is an influence of infrared light on the input image, white balance is shifted in the direction of magenta, and thus the Red gain and the Blue gain can be set to smaller values than when there is no influence of infrared light, whereby it is possible to maintain appropriate white balance even when there is an influence of infrared light.

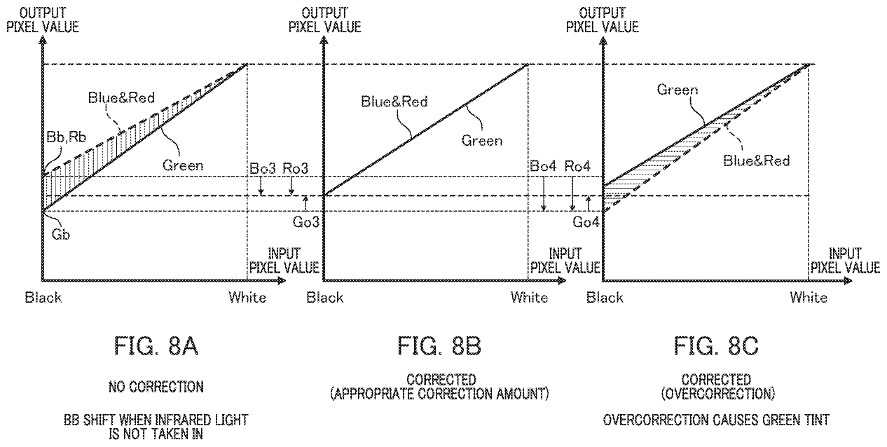

Effects of the second embodiment will be described below. FIGS. 8A to 8C are diagrams illustrating an example of control of a black balance correction value (offset) when infrared light is not taken in in the second embodiment.

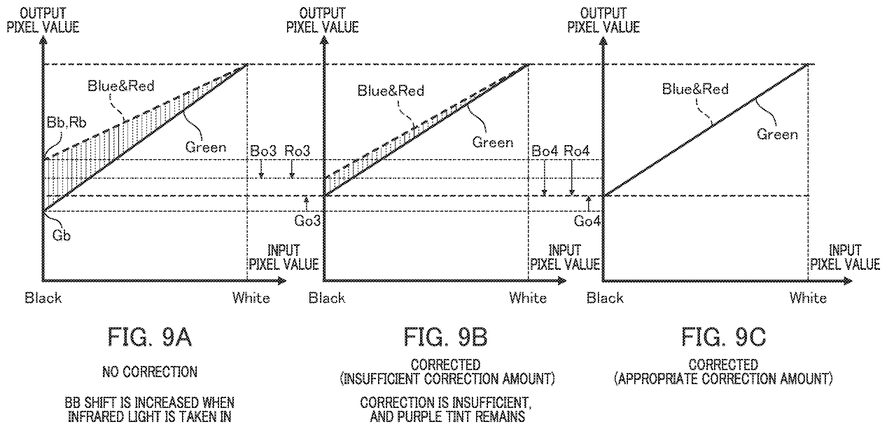

Further, FIGS. 9A to 9C are diagrams illustrating an example of control of a black balance correction value (offset) when infrared light is taken in in the second embodiment. That is, FIGS. 8A to 8C illustrate an example of a case where there is no influence of infrared light on an input image, and FIGS. 9A to 9C illustrate an example of a case where there is an influence of infrared light on an input image.

In the case of no black balance correction in FIG. 8A, it is indicated that an output pixel value in Black is larger for Blue and Red than for Green, and the black balance is shifted to Mg.

The larger a sensor gain is, the larger a shift amount of black balance becomes. On the other hand, an output pixel value in White has an appropriate white balance, pixel values for Red, Green, and Blue are substantially the same, and no coloration occurs.

Even when black balance correction in FIG. 9A is not performed, it is indicated that an output pixel value in Black is larger for Blue and Red than for Green, and the black balance is shifted to Mg.

However, since there is an influence of infrared light, a shift of black balance becomes greater than when there is no influence of infrared light. On the other hand, an output pixel value in White has an appropriate white balance, pixel values for Red, Green, and Blue are substantially the same, and no coloration occurs.

In the case of FIG. 8B, after black balance is corrected, in an output pixel value in Black, pixel values for Red, Green, and Blue are substantially the same, and no coloration occurs. On the other hand, in the case of FIG. 9B, an offset amount is the same as that in FIG. 8B, but a shift of black balance expands due to the influence of infrared light, resulting in insufficient correction, and the black balance is shifted to a Mg side.

FIG. 8C illustrates an example in which a correction amount of black balance is increased compared to the case of FIG. 8B. In FIG. 8C, the black balance is overcorrected, and the black balance is shifted to a G side.

On the other hand, in the case of FIG. 9C, although an offset amount is the same as that in FIG. 8C, output pixel values in Black are substantially the same for Red, Green, and Blue, and the black balance is not shifted.

From the above, when an optimal offset amount is set when there is no influence of infrared light, insufficient correction of black balance occurs when there is an influence of infrared light. On the other hand, when an optimal offset amount is set when there is an influence of infrared light, overcorrection of black balance occurs when there is no influence of infrared light.

Thus, in the second embodiment, when there is no influence of infrared light, the offset amount as illustrated in FIG. 8 (B) is applied, and when there is an influence of infrared light, the offset amount as illustrated in FIG. 9 (C) is applied.

That is, in the black balance correction of the second embodiment, the BB offset calculation unit 203 calculates an offset amount of the black balance correction with reference to a shift amount of black balance and whether there is an influence of infrared light. For this reason, an appropriate offset amount can be applied depending on whether there is an influence of infrared light.

Specifically, as described above, an offset amount is set to be larger whether there is an influence of infrared light, and an offset amount is set to be smaller whether there is no influence of infrared light, and thus it is possible to perform appropriate black balance correction according to whether there is an influence of infrared light.

### Third Embodiment

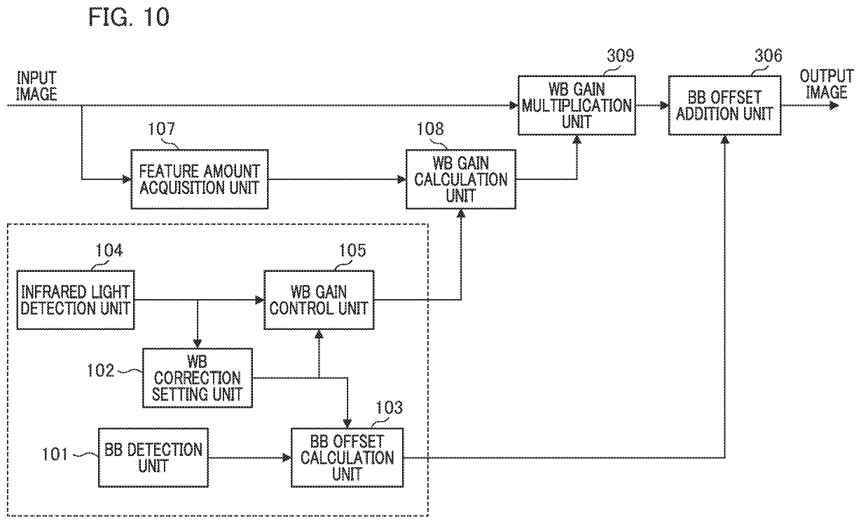

Next, an image processing apparatus according to a third embodiment of the present disclosure will be described with reference to FIG. 10.

In the third embodiment, in a configuration in which an input image is multiplied by a white balance gain and then an offset is added thereto, an offset amount for correcting black balance is determined based on a shift amount of black balance and a shift amount of white balance. Furthermore, in the third embodiment, when infrared light is taken in and imaged, white balance can be intentionally shifted in accordance with a setting value.

Originally, it would be desirable to adjust black balance by adding an offset and then adjust white balance by multiplying a white balance gain. However, depending on circumstances of a system configuration, offset addition for black balance adjustment may be performed after multiplying a white balance gain, and the third embodiment is suitable for such a case.

FIG. 10 is a functional block diagram illustrating an example of a functional configuration of the image processing apparatus according to the third embodiment. The same functional blocks as those in the first embodiment are denoted by the same reference numerals, and the descriptions thereof will be omitted.

A BB offset addition unit 306 acquires an image multiplied by a white balance gain from a WB gain multiplication unit 309 and acquires offset amounts for R, G, and B from a BB offset calculation unit 103. Then, the offset amounts are added to an image obtained by multiplying an input image by a white balance gain to generate an output image, and the output image is output.

The WB gain multiplication unit 309 acquires a white balance gain from a WB gain calculation unit 108, multiplies an input image by the white balance gain, and outputs the image multiplied by the white balance gain to the BB offset addition unit 306.

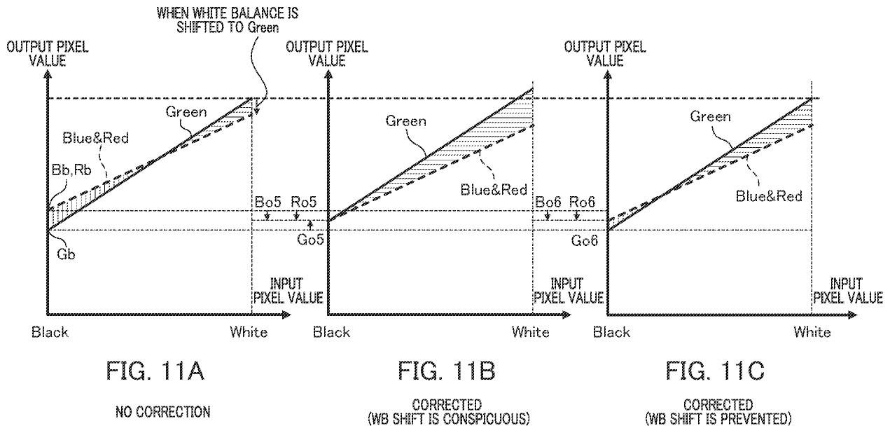

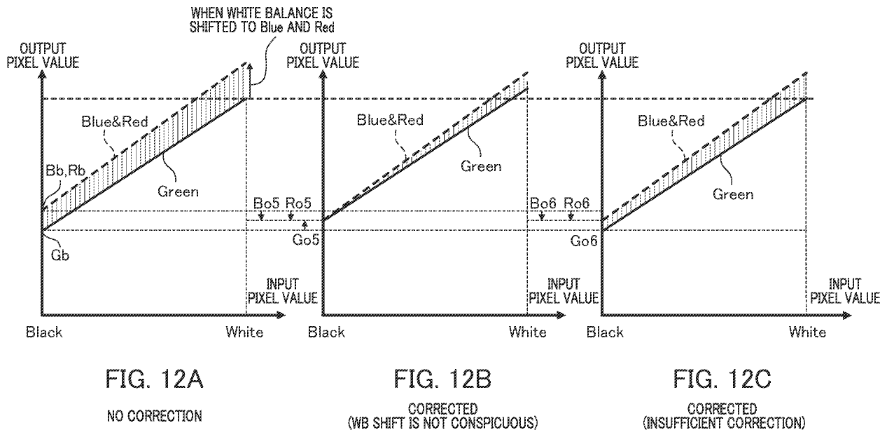

Effects of the third embodiment will be described below. FIGS. 11A to 11C are diagrams illustrating an example of control of a black balance correction value (offset) when WB is shifted to a G side in the third embodiment. FIGS. 12A to 12C are diagrams illustrating an example of control of black balance when WB is shifted to R and B sides in the third embodiment.

In the case of no black balance correction in FIG. 11A, it is indicated that an output pixel value in Black is larger for Blue and Red than for Green, and the black balance is shifted to Mg.

Such a phenomenon is more likely to occur as a sensor gain is larger, and the larger the sensor gain is, the larger a shift amount of black balance becomes. On the other hand, it is indicated that an output pixel value in White is larger for Green than for Blue and Red, and the white balance is shifted to a G side based on a setting value of a WB correction setting unit 102. That is, the white balance and the black balance are shifted in opposite directions.

In the case of no black balance correction in FIG. 12A, it is indicated that an output pixel value in Black is larger for Blue and Red than for Green, and the black balance is shifted to Mg.

On the other hand, it is indicated that an output pixel value in White is also larger for Blue and Red than for Green, and the white balance is shifted to a Mg side based on a setting value of the WB correction setting unit 102. That is, the white balance and the black balance are shifted in the same direction.

In the case of FIG. 11B, after black balance is corrected, in an output pixel value in Black, pixel values for Red, Green, and Blue are substantially the same, and no coloration occurs. On the other hand, in the third embodiment, an offset is added after a white balance gain is multiplied, and thus a shift amount of white balance is increased compared to FIG. 11A. As a result, in the case of FIG. 11B, a green tint becomes conspicuous in an output image.

On the other hand, in the case of FIG. 12B, after black balance is corrected, in an output pixel value in Black, pixel values for Red, Green, and Blue are substantially the same, and no coloration occurs. Although white balance as illustrated in FIG. 12A cannot be maintained, there is little sense of discomfort in image quality because a change is made in a direction in which a shift amount of white balance decreases, that is, a direction in which coloration decreases.

FIG. 11C illustrates an example in which an offset amount is smaller than that in FIG. 11B. In FIG. 11C, shift amounts of black balance and white balance are intermediate between those in the case of FIG. 11A and those in the case of FIG. 11B. That is, it is possible to prevent black balance from being shifted to magenta compared to the case of FIG. 11A and to suppress an excessive shift of white balance to Green compared to the case of FIG. 11B.

FIG. 12C also illustrates an example in which an offset amount is smaller than that in FIG. 12B. In FIG. 12C, shift amounts of black balance and white balance are intermediate between those in the case of FIG. 12A and those in the case of FIG. 12B. That is, black balance is prevented from being shifted to magenta compared to the case of FIG. 12A, and it is easier to maintain white balance in the case of FIG. 12A than in the case of FIG. 12B.

As described above, when shifts to different color sides occur in White and Black before black balance is corrected, the correction of black balance may cause an increase in a shift of white balance, and the increase in a shift of white balance may increase a sense of discomfort in image quality.

Thus, in the third embodiment, when shifts to different color sides occur in White and Black before black balance is corrected, an offset amount is set to be smaller. In other words, as illustrated in FIG. 11A, when shifts to different color sides occur in White and Black before black balance is corrected, an offset amount is set to be smaller as illustrated in FIG. 11C.

On the other hand, as illustrated in FIG. 12A, when shifts to the same color side occur in White and Black before black balance is corrected, a shift of white balance is not increased even when black balance is corrected, and thus there is little sense of discomfort in image quality even when an offset amount is increased.

That is, in the third embodiment, as illustrated in FIG. 12A, when shifts to the same color side occur in White and Black before black balance is corrected, an offset amount is set to be larger as illustrated in FIG. 12B.

In this manner, in the third embodiment, when an input image is multiplied by a white balance gain and then an offset is added thereto, the BB offset calculation unit 103 determines an offset amount with reference to a shift amount of black balance and a shift amount of white balance. For this reason, an appropriate offset amount can be applied depending on how white balance is shifted.

Specifically, as described above, when shifts to different color sides occur in White and Black, an offset amount is set to be smaller, and when shifts to the same color side occur in White and Black, an offset amount is set to be larger. Thus, it is possible to perform black balance correction suitable for white balance.

In the third embodiment, as illustrated in FIG. 11A, when white balance is shifted to Green before black balance is corrected, an offset addition amount for Green is set to Go6 illustrated in FIG. 11C which has an absolute value smaller than that of Go5 in FIG. 11B.

On the other hand, as illustrated in FIG. 12A, when white balance is shifted to Blue and Red before black balance is corrected, an offset addition amount for Green is set to Go5 illustrated in FIG. 12B which has an absolute value larger than that of Go6 in FIG. 12C. However, the present disclosure is not limited thereto.

That is, when white balance is shifted to Green before black balance is corrected, it is only required that absolute values of offset subtraction amounts for Blue and Red are set to be smaller than those when white balance is shifted to Blue and Red before black balance is corrected.

On the other hand, when white balance is shifted to Blue and Red before black balance is corrected, it is only required that absolute values of offset subtraction amounts for Blue and Red are set to be larger than those when white balance is shifted to Green before black balance is corrected.

### Fourth Embodiment

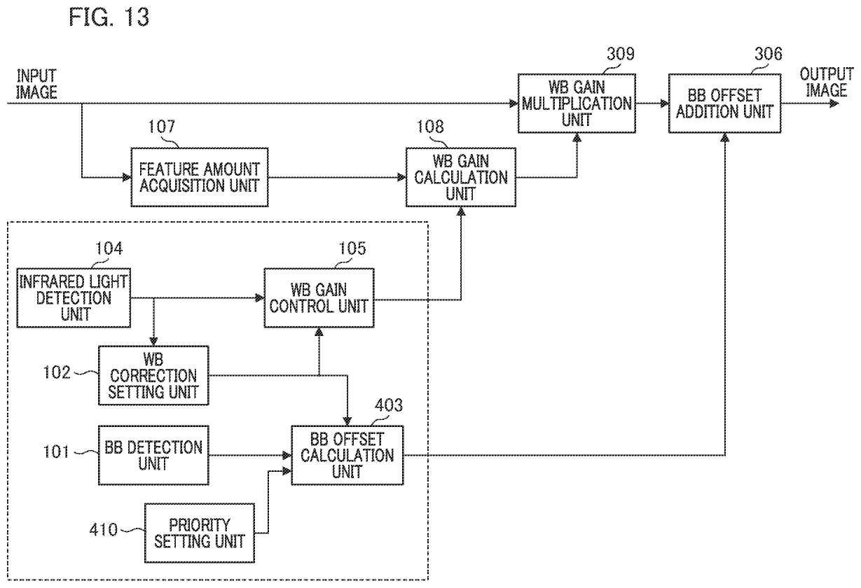

Next, an image processing apparatus according to a fourth embodiment of the present disclosure will be described with reference to FIG. 13. In the fourth embodiment, any one gradation among intermediate gradations between Black and White is set as a priority gradation, and black balance is corrected by giving priority to the priority gradation.

Similarly to the third embodiment, in the fourth embodiment, a configuration in which an input image is multiplied by a white balance gain and then an offset is added thereto is adopted. Furthermore, an offset amount for correcting black balance is determined based on a shift amount of black balance and a shift amount of white balance.

Furthermore, in the fourth embodiment, when infrared light is taken in and imaged, white balance can be intentionally shifted in accordance with a setting value.

FIG. 13 is a functional block diagram illustrating an example of a functional configuration of the image processing apparatus according to the fourth embodiment. The same functional blocks as those in the first embodiment and the third embodiment are denoted by the same reference numerals, and the descriptions thereof will be omitted.

A BB offset calculation unit 403 acquires a shift amount of black balance from a BB detection unit 101, acquires a shift amount of white balance from a WB correction setting unit 102, and acquires a priority gradation value from a priority setting unit 410. Then, offset amounts for R, G, and B for correcting black balance are calculated and output to a BB offset addition unit 106.

The priority setting unit 410 sets any one gradation among intermediate gradations between Black and White as a priority gradation, and outputs a priority gradation value to the BB offset calculation unit 403. The priority setting unit 410 sets the priority of a gradation value.

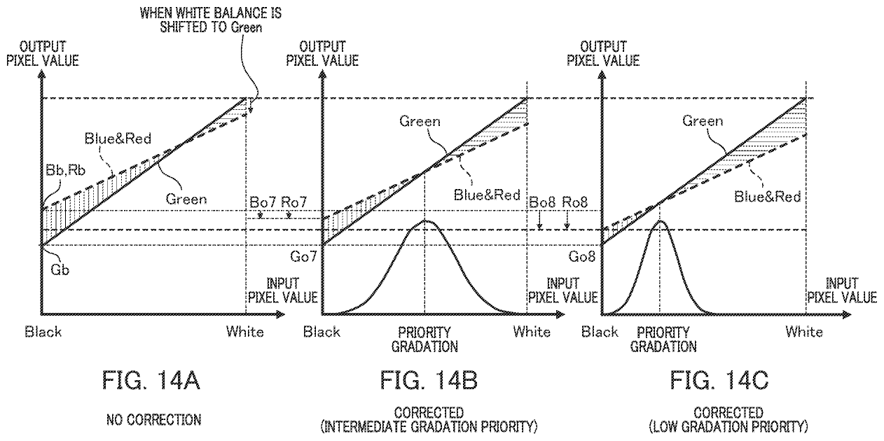

The operation of the BB offset calculation unit 403 according to the fourth embodiment and effects of the fourth embodiment will be described with reference to FIG. 14. FIGS. 14A to 14C are diagrams illustrating an example of control of a black balance correction value (offset) according to the fourth embodiment.

In the case of no black balance correction in FIG. 14A, it is indicated that an output pixel value in Black is larger for Blue and Red than for Green, and black balance is shifted to a Mg side. Such a phenomenon is more likely to occur as a sensor gain is larger, and the larger the sensor gain is, the larger the shift amount of black balance becomes.

On the other hand, it is indicated that an output pixel value in White is larger for Green than for Blue and Red, and the white balance is shifted to a G side based on a setting value of the WB correction setting unit 102. That is, colors are shifted in opposite directions in white balance and black balance.

In such a case, with a configuration in which an input image is multiplied by a white balance gain and then an offset is added thereto, an increase in an offset amount results in a decrease in a shift of black balance, whereas a shift of white balance is increased.

In contrast, when an offset amount is reduced, a shift of black balance cannot be reduced, but it is possible to prevent a shift of white balance from becoming large. In other words, a trade-off between a shift amount of black balance and a shift amount of white balance occurs.

Consequently, in the fourth embodiment, the BB offset calculation unit 403 determines an offset amount by giving priority to the priority gradation acquired from the priority setting unit 410. Specifically, for example, an offset amount is determined such that a shift of white balance of the priority gradation is eliminated.

FIG. 14B illustrates a case where an exactly intermediate gradation between Black and White is set as a priority gradation. In the case of FIG. 14B, a shift of black balance is smaller than that in FIG. 14A, and there is no shift of white balance in the priority gradation.

On the other hand, FIG. 14C illustrates a case where a gradation value of a gradation lower than that in the case of FIG. 14B is set as a priority gradation. An offset amount is larger than in the case of FIG. 14B. For this reason, a shift of white balance in White is large, but a shift of black balance is smaller than that in FIG. 14B, and there is no shift of white balance in the priority gradation.

In the fourth embodiment, the priority setting unit 410 directly sets a gradation value when setting a priority gradation, but the present disclosure is not limited thereto. For example, a priority gradation may be set based on a brightness setting value of an imaging device which is not illustrated in the drawing, a setting value for shifting the exposure of the imaging device to an under side or an over side, a most frequent value of a luminance histogram of an input image, and the like.

### Fifth Embodiment

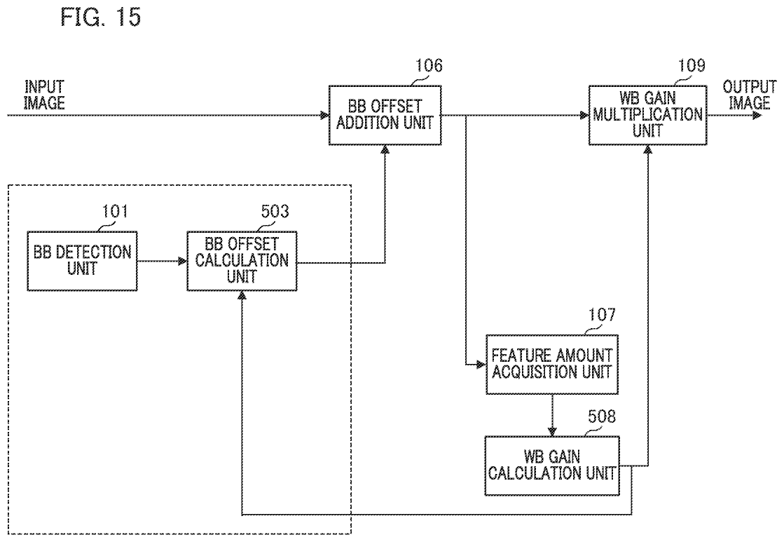

Hereinafter, an image processing apparatus according to a fifth embodiment of the present disclosure will be described with reference to FIG. 15.

In the fifth embodiment, in a configuration in which an offset is added to an input image and then multiplied by a white balance gain, an offset amount for correcting black balance is determined based on a shift amount of black balance and a color temperature of a light source in an imaging environment.

FIG. 15 is a functional block diagram illustrating an example of a functional configuration of the image processing apparatus according to the fifth embodiment. The same functional blocks as those in the first embodiment are denoted by the same reference numerals, and the descriptions thereof will be omitted.

A BB offset calculation unit 503 acquires a shift amount of black balance from a BB detection unit 101 and acquires a color temperature in an imaging environment from a WB gain calculation unit 508, calculates offset amounts for R, G, and B, and outputs the offset amounts to a BB offset addition unit 106.

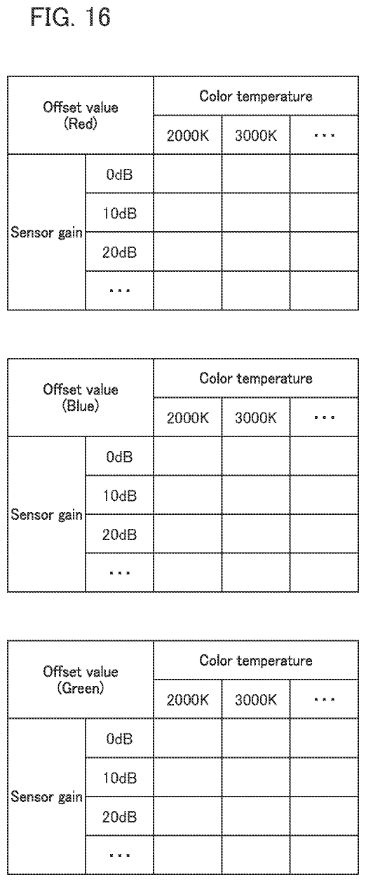

An offset amount for each color is determined, for example, with reference to an LUT as illustrated in FIG. 16. FIG. 16 is a diagram illustrating an example of an LUT of an offset amount for each of R, G, and B according to the fifth embodiment. As illustrated in FIG. 16, an offset amount for each color may be determined with reference to an LUT in which a sensor gain (a shift amount of black balance) and a color temperature in an imaging environment are associated with each other.

A WB gain calculation unit 508 acquires color information for each region of an image from a feature amount acquisition unit 107 to calculate a white balance gain (WB gain), and outputs the white balance gain to the WB gain multiplication unit 109. Further, the WB gain calculation unit 508 calculates a color temperature in an imaging environment from the color information acquired from the feature amount acquisition unit 107 or the calculated WB gain, and outputs the color temperature to the BB offset calculation unit 503.

It is only required that the color temperature is calculated with reference to a previously created LUT, which is not illustrated in the drawing, representing correspondence between a white balance gain and a color temperature, or an LUT, which is not illustrated in the drawing, representing correspondence between color information of an image and a color temperature.

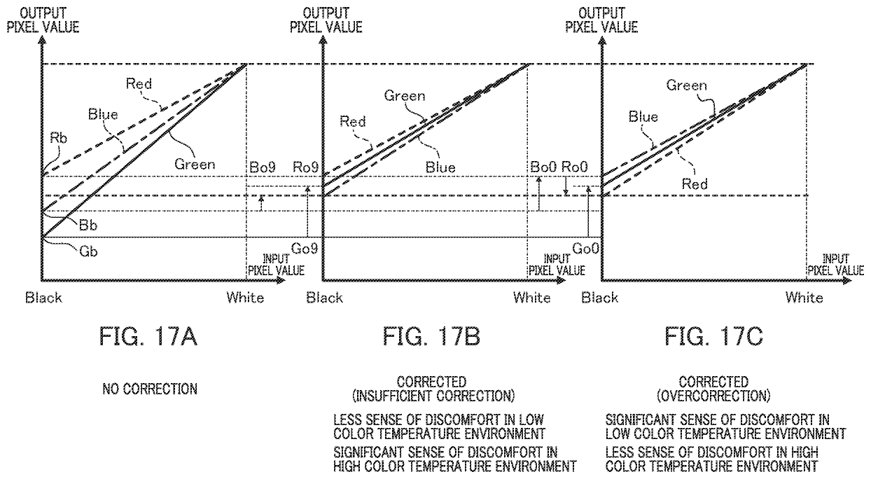

Effects of the fifth embodiment will be described below. FIGS. 17A to 17C are diagrams illustrating an example of control of a black balance correction value (offset) according to the fifth embodiment. FIGS. 17A to 17C illustrate an example of characteristics of a pixel value of an input image and pixel values of respective colors of R, G, and B of an output image when subjects of achromatic colors ranging from black (Black) to white (White) are imaged.

In the case of no black balance correction in FIG. 17A, it is indicated that an output pixel value in Black is larger for Blue and Red than for Green and is larger for Red than for Blue, and black balance is shifted from a red side to a purple side. Such a phenomenon is more likely to occur as a sensor gain is larger, and the larger the sensor gain is, the larger the shift amount of black balance becomes.

In the case of FIG. 17B, an output pixel value in Black is larger for Red than for Green and is smaller for Blue than for Green. Thus, black balance is shifted to an under side.

That is, the black balance is shifted to a color that is close to the color of a lighting with a low color temperature, and when the color temperature of a lighting in an imaging environment is low, there is little sense of discomfort even when the black balance is shifted to a low color temperature side. On the other hand, when the color temperature of the lighting in the imaging environment is high, a sense of discomfort is significant when the black balance is shifted to a low color temperature side.

In the case of FIG. 17C, an offset amount is larger than in the case of FIG. 17B. Further, in the case of FIG. 17C, an output pixel value in Black is larger for Blue than for Green and is smaller for Red than for Green.

Thus, black balance is shifted from blue to cyan. That is, the black balance is shifted to a color close to the color of a lighting with a high color temperature, and when the color temperature of a lighting in an imaging environment is high, there is little sense of discomfort even when the black balance is shifted to a high color temperature side. On the other hand, when the color temperature of the lighting in the imaging environment is low, a sense of discomfort is significant when the black balance is shifted to a high color temperature side.

As described above, when black balance is shifted from red to purple and when the color temperature of the lighting in the imaging environment is low, it is desirable that an offset amount be relatively small as illustrated in FIG. 17B. On the other hand, when the black balance is shifted from red to purple and the color temperature of the lighting in the imaging environment is high, it is desirable that an offset amount be relatively large as illustrated in FIG. 17C.

When the black balance is shifted from cyan to blue, these are reversed. That is, when the black balance is shifted from cyan to blue and the color temperature of the lighting in the imaging environment is low, it is desirable that an offset amount be relatively large as illustrated in FIG. 17C. On the other hand, when the black balance is shifted from cyan to blue and the color temperature of the lighting in the imaging environment is high, it is desirable that an offset amount be relatively small as illustrated in FIG. 17B.

In the fifth embodiment, a WB gain control unit 105 may control white balance based on a shift of black balance detected by a BB detection unit 101. For example, white balance is controlled in accordance with an offset value of black balance. Thereby, it becomes easier to maintain the color tone of a subject having an intermediate luminance or higher as intended by the user by the offset of the black balance.

### Sixth Embodiment

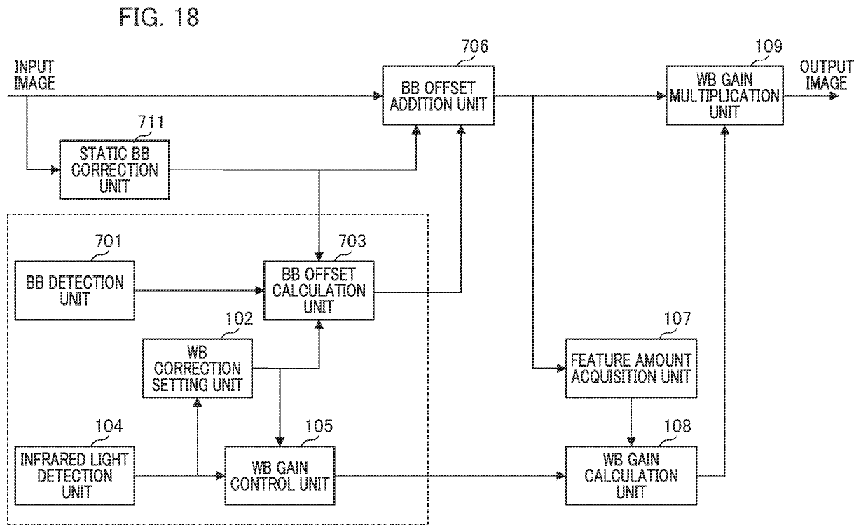

Hereinafter, an image processing apparatus according to a sixth embodiment of the present disclosure will be described with reference to FIG. 18.

In the sixth embodiment, in a configuration in which an offset is added to an input image and then multiplied by a white balance gain, an offset amount for correcting black balance is determined based on a shift amount of black balance and a shift amount of white balance. Further, in the sixth embodiment, a shift amount of black balance or a correction amount of black balance is determined based on temperature information or temperature information and a sensor gain.

FIG. 18 is a functional block diagram illustrating an example of a functional configuration of the image processing apparatus according to the sixth embodiment. The same functional blocks as those in the first embodiment are denoted by the same reference numerals, and the descriptions thereof will be omitted.

A static BB correction unit 711 calculates black levels of R, G, and B at a predetermined timing based on an acquired input image. Then, in order to correct a shift of a black level for each of R, G, and B, that is, black balance, an offset amount of static black balance, which is an offset amount for correcting the black level for each of R, G, and B, is calculated, and the offset amount is output to a BB offset addition unit 706.

Further, the static BB correction unit 711 outputs temperature information when calculating a static offset amount to a BB offset calculation unit 703. Here, the static offset amount is an offset amount that is calculated only at a predetermined timing and does not change sequentially. A shift of black balance that is measured only at a predetermined timing and corrected in accordance with a static offset amount will be referred to as a “shift of static black balance” below.

The shift of static black balance refers to a shift of black balance that little changes sequentially and changes gradually over a relatively long period of time, such as a shift of black balance due to deterioration of a sensor with the elapse of time. Further, the predetermined timing is, for example, a timing at which black balance is adjusted at a factory during manufacturing before shipping, a timing at which an imaging device capturing an input image is started up, a timing at which a user intentionally performs black balance calibration, a predetermined time, and the like.

Calibration of a static offset amount is performed, for example, with a sensor gain that is set in advance in a state where a sensor is shielded from light. The static offset amount measured during calibration may be stored in a nonvolatile storage device or a volatile storage device.

A BB detection unit (detection unit) 701 detects a shift amount of black balance, and outputs the shift amount of black balance to the BB offset calculation unit 703. The higher a sensor gain, sensor temperature, and temperature in an imaging environment when an input image is captured, the greater a shift of black balance becomes. Thus, the BB detection unit 701 outputs, for example, the value of the sensor gain and temperature at the time of capturing the input image to the BB offset calculation unit 703 as a shift amount of black balance.

The BB offset calculation unit 703 acquires the sensor gain and temperature value from the BB detection unit 701 as a shift amount of black balance. Furthermore, the BB offset calculation unit 703 acquires a shift amount of white balance from a WB correction setting unit 102, calculates offset amounts for R, G, and B, and outputs the offset amounts to the BB offset addition unit 706.

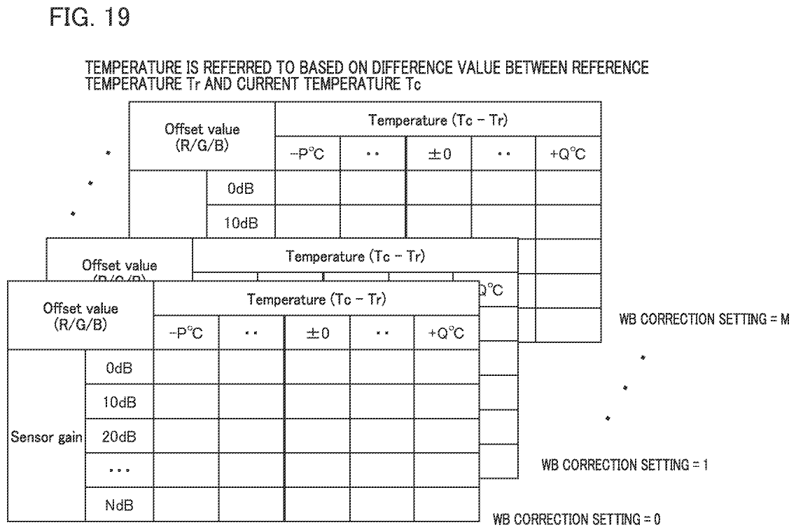

The offset amount calculated by the BB offset calculation unit 703 is a dynamic offset amount that sequentially fluctuates depending on the current gain and temperature. The dynamic offset amount is determined, for example, with reference to an LUT as illustrated in FIG. 19.

FIG. 19 is a diagram illustrating an example of an LUT according to the sixth embodiment. FIG. 19 illustrates an example of an LUT in which a sensor gain and temperature representing a shift amount of black balance are associated with a WB correction setting (shift amount of white balance).

Such an LUT is provided for each of R, G, and B. In FIG. 19, M represents a maximum value of a WB correction setting value, and N represents a maximum value of a sensor gain. Regarding the temperature, (Tc-Tr) which is a difference between a temperature value (Tc) acquired from the BB detection unit 701 and a reference temperature value (Tr) is used.

A minimum value of (Tc-Tr) is-P, and a maximum value is Q. The reference temperature value (Tr) may be a predetermined value, may be a temperature at a point in time when LUT data is created, or may be a temperature value at a timing at which the static BB correction unit 711 calculates a static offset amount.

Alternatively, the reference temperature value (Tr) may be able to be set from the outside. In that case, for example, it is only required to adopt a configuration in which a setting operation is received such that the user can set a temperature value obtained by separately measuring an average temperature in an imaging environment.

In the sixth embodiment, a temperature used when referring to the LUT is (Tc-Tr), but the present disclosure is not limited thereto. For example, the temperature value (Tc) itself acquired from the BB detection unit 701 may be used for reference.

The BB offset addition unit 706 acquires the dynamic offset amounts for R, G, and B from the BB offset calculation unit 703, and acquires the static offset amounts for R, G, and B from the static BB correction unit 711.

Then, the BB offset addition unit 706 adds the dynamic offset amounts acquired from the BB offset calculation unit 703 and the static offset amounts acquired from the static BB correction unit 711 to an input image, and outputs the offset-added image to a feature amount acquisition unit 107 and a WB gain multiplication unit 109.

Effects of the sixth embodiment will be described below. In the black balance correction of the sixth embodiment, the BB offset calculation unit 703 determines a dynamic offset amount with reference to a shift amount of black balance and a shift amount of white balance.

For this reason, it is possible to apply an appropriate offset amount depending on how white balance is shifted, and it is possible to perform black balance correction suitable for white balance. In addition, since the BB offset calculation unit 703 determines a dynamic offset amount based on a temperature, it is also possible to appropriately correct a shift of black balance that occurs at a high temperature.

Furthermore, in the black balance correction of the sixth embodiment, the BB offset calculation unit 703 determines a dynamic offset correction amount with reference to both a temperature and a sensor gain. The larger the sensor gain is, the more likely black balance is shifted at a high temperature. Thus, when an offset correction amount suitable for a high gain and high temperatures is applied in the case of a low gain and high temperature, there is a concern that overcorrection of black balance may occur.

Alternatively, when an offset correction amount suitable for a low gain and high temperature is applied to the case of a high gain and high temperature, there is a concern that insufficient correction of black balance may occur. That is, when a correction amount of black balance is determined in accordance with only a temperature, there is a concern that overcorrection and insufficient correction of black balance may occur.

In the black balance correction in the sixth embodiment, an offset correction amount is determined with reference to both a temperature and a sensor gain, and thus it is possible to apply different offset correction amounts in the case of a high gain and high temperature and the case of a low gain and high temperature. Thus, it is possible to prevent overcorrection in the case of a low gain and high temperature or insufficient correction in the case of a high gain and high temperature and to appropriately correct a shift of black balance.

Further, in the black balance correction of the sixth embodiment, the BB offset calculation unit 703 calculates a dynamic offset amount for correcting black balance based on (Tc-Tr) which is a difference between a temperature value (Tc) acquired from the BB detection unit 701 and a reference temperature value (Tr).

In general, as a temperature increases, a dark current of an imaging sensor increases, which increases a shift of black balance. Thus, assuming that (Tc) is a value that fluctuates depending on the current temperature and (Tr) is a fixed value, the larger (Tc-Tr) becomes, the larger an offset amount for correcting black balance becomes.

Consequently, in the sixth embodiment, for example, an LUT is provided such that an offset amount is a value other than 0 when (Tc-Tr) is larger than 0, and an offset amount is 0 when (Tc-Tr) is equal to or less than 0. That is, the LUT is designed such that black balance correction is performed in accordance with a temperature when (Tc-Tr) is greater than 0, and black balance correction is not performed in accordance with a temperature when (Tc-Tr) is equal to or less than 0.

In other words, the LUT is designed to perform black balance correction only when the current temperature value (Tc) is larger than the reference temperature value (Tr). In this manner, in the black balance correction of the sixth embodiment, a temperature at which black balance correction is applied depending on a temperature can be changed by only changing (Tr).

For example, by separately providing a means by which the user can set (Tr), black balance correction can be applied when a temperature is equal to or higher than a temperature desired by the user.

Further, in the black balance correction of the sixth embodiment, the static BB correction unit 711 calculates a static offset amount when the user performs a black balance calibration operation or the like. This static offset amount is determined during the calibration operation and maintains a constant value until the calibration operation is performed again.

In other words, the static offset amount is an offset amount suitable for a temperature at a point in time when the calibration operation is performed. In the sixth embodiment, the BB offset calculation unit 703 sets a temperature at a point in time when the calibration operation is performed as a reference temperature value (Tr). Furthermore, a dynamic offset amount for correcting black balance is calculated based on a difference (Tc-Tr) between the current temperature value (Tc) and the reference temperature value (Tr).

That is, a dynamic offset amount for correcting black balance is calculated in accordance with a difference between the current temperature and a temperature at the time of calibration. Then, the BB offset addition unit 706 adds the dynamic offset amount and the static offset amount to an input image to correct black balance.

As described above, in black balance correction performed by user calibration, a “shift of static black balance” is corrected. The “shift of static black balance” is, for example, a shift of black balance due to deterioration of a sensor with the elapse of time. When measuring a shift of black balance due to deterioration of the sensor with the elapse of time, it is necessary to fix the settings (for example, a sensor gain and the like) of the imaging device every time measurement is performed.

However, when user calibration is performed, a settable measurement condition such as a sensor gain can be fixed, but a temperature cannot be fixed because it depends on an environment. That is, the temperature when performing black balance correction by user calibration may be high or low.

When black balance correction based on user calibration is executed at a high temperature, a static offset amount suitable for a high temperature is applied. In this case, assuming that the current temperature is also high, the BB offset calculation unit 703 also applies a dynamic offset correction amount suitable for a high temperature.

That is, when black balance correction based on user calibration is executed at a high temperature and the current temperature is also high, the static offset amount and the dynamic offset amount both become offset correction amounts suitable for a high temperature, resulting in over-correction. In other words, when black balance correction based on user calibration is executed at a high temperature, dynamic offset correction at a high temperature is not necessary because black balance correction suitable for a high temperature has already been applied.

On the other hand, in the black balance correction of the sixth embodiment, the BB offset calculation unit 703 calculates a dynamic offset amount for correcting black balance based on (Tc-Tr) which is a difference between a temperature (Tr) at the time of a calibration operation and a current temperature value (Tc).

Then, as (Tc-Tr) increases, the dynamic offset amount for correcting black balance also increases, and thus as the current temperature value (Tc) becomes larger than the temperature (Tr) at the time of a calibration operation, the dynamic offset amount becomes larger. That is, even when a static offset amount that is set at a low temperature is small, a dynamic offset amount that is set at a high temperature becomes correspondingly large, and thus insufficient correction can be prevented.

On the other hand, as (Tc-Tr) decreases, a dynamic offset amount for correcting black balance also becomes small (close to 0). Thus, as the current temperature value (Tc) becomes lower than a temperature (Tr) at the time of a calibration operation, a dynamic offset amount also becomes small (close to 0). That is, even when a static offset amount that is set at a high temperature is large, a dynamic offset amount that is set at a high temperature becomes correspondingly small, and thus overcorrection can be prevented.

Here, an additional description for a static offset amount and a dynamic offset amount will be given. As described above, the static offset amount is measured in a state where the sensor is shielded from light. That is, the static offset amount is an offset correction amount with higher correction accuracy which is acquired by accurately measuring and calculating a black level for each of R, G, and B in a state where an imaging region of the sensor is shielded from light, for example, by mounting a lens cap or fully closing an aperture.

However, it is not suitable for real-time offset correction because it takes time to perform measurement or the imaging of a subject is interrupted due to light shielding. On the other hand, the dynamic offset amount is obtained by estimating a shift amount of black balance based on a sensor gain and a temperature, and is an offset correction amount that can be calculated in real time based on information that can be acquired while performing imaging.

However, the dynamic offset amount is not suitable for estimating a shift amount of black balance which is determined by complicated conditions such as the degree of sensor deterioration. For example, in a use case such as a monitoring camera, it is required to continuously perform imaging for monitoring, and a usage time is long, and thus it may be necessary to perform correction for deterioration with the elapse of time.

In order to meet such a demand, in the sixth embodiment, changes in black balance that occurs over a relatively short period of time, such as changes in temperature or illuminance during the day, are corrected in real time based on a dynamic offset amount. On the other hand, changes in black balance caused by the elapse of a relatively long period of time, such as deterioration with the elapse of time, are corrected accurately based on a static offset amount.

The degree of deterioration with the elapse of time changes depending on an installation environment of an imaging device, or the like, and thus the deterioration with the elapse of time can be corrected more accurately based on a static offset amount measured during calibration or the like than when the deterioration is simply estimated from an elapsed time. In addition, the measurement timing of the static offset amount is set to be a timing designated by the user, and thus it is possible to prevent a video of the monitoring camera from being interrupted at a timing that is not expected by the user.

In the sixth embodiment, the BB offset calculation unit 703 determines a dynamic offset correction amount with reference to both a temperature and a sensor gain, but the present disclosure is not limited thereto. For example, the dynamic offset correction amount may be determined based on a temperature and illuminance in an imaging environment.

An increase in a dark current generated in the sensor is considered to be one cause of a shift of black balance. In a low illuminance environment, there are few signal components derived from photoelectric conversion included in an output signal of the sensor, and there are a relatively large number of signal components derived from a dark current, and thus a shift of black balance becomes more conspicuous. Furthermore, as the temperature of the sensor becomes higher, the dark current increases, and thus a shift of black balance becomes larger.

Thus, the BB offset calculation unit 703 can more appropriately correct black balance by determining a dynamic offset correction amount based on both a temperature and illuminance in an imaging environment.

For example, when a gain, a shutter speed (charge accumulation time), and an aperture value (F value) are automatically controlled in accordance with the illuminance in the imaging environment, the illumination in the imaging environment may be estimated from a gain, a shutter speed, and an iris aperture value.

That is, it can be determined that the larger the gain, the slower the shutter speed, and the smaller the aperture value, the lower the illuminance in the imaging environment. In other words, a dynamic offset correction amount may be determined based on both the temperature and the illuminance in the imaging environment with reference to at least one of the gain, the shutter speed, and the aperture value and the temperature.

A method of estimating an illuminance in an imaging environment is not limited to a method of estimating an illuminance from a gain, a shutter speed, and an aperture value. An illuminance sensor may be separately provided, and its measured values may be used.

In the sixth embodiment, the static BB correction unit 711 outputs temperature information when calculating a static offset amount to the BB offset calculation unit 703, but the present disclosure is not limited thereto. That is, an average value of the static offset amounts calculated by the static BB correction unit 711 may be output to the BB offset calculation unit 703.

Alternatively, an average value of black levels for R, G, and B of an input image, or the like used to calculate a static offset amount may be output to the BB offset calculation unit 703. In this case, it is only required that the BB offset calculation unit 703 refer to an LUT for determining a dynamic offset amount based on the average value of the static offset amount or the average value of the black levels for R, G, and B of the input image.

A method of calculating an offset amount for correcting black balance may be changed depending on the type of sensor. Examples of type of sensor include a sensor using an avalanche photodiode, a photon counting type imaging sensor, an SPD sensor, and the like. SPD is an abbreviation for Single Photon Avalanche Diode.

Types of sensors can include a CMOS sensor, a CCD sensor, or other types of sensors. Since characteristics of a dark current of the sensor vary depending on the type of sensor, black balance is shifted differently depending on the type of sensor. The type of sensor includes at least one of the plurality of sensors described above.

Consequently, for example, an LUT for calculating an offset amount for correcting black balance may be switched depending on the type of sensor. That is, it is possible to perform appropriate black balance correction in accordance with the type of sensor with reference to an LUT having an offset correction amount suitable for the type of sensor.

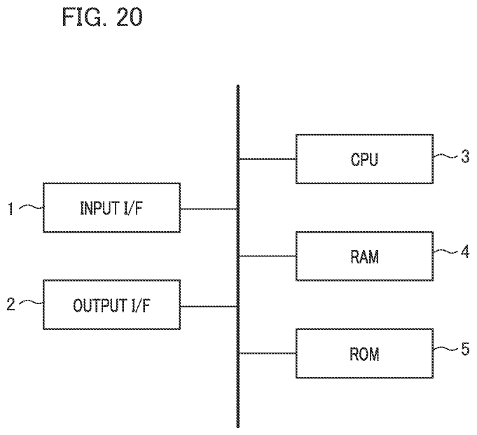

FIG. 20 is a diagram illustrating an example of a hardware configuration of an image processing apparatus according to the present disclosure. The hardware configuration of FIG. 20 includes an input interface (I/F) 1, an output I/F 2, a CPU 3, a read only memory 4, a read-only memory 5, and can include other components. The hardware configuration of FIG. 20 can be used with any of the embodiments described above.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing apparatus through a network or various storage media. Then, a computer (or a CPU, a micro processing unit (MPU), or the like) of the image processing apparatus may be configured to read and execute the program. In such a case, the program and the storage medium storing the program configure the present disclosure.

Further, the present disclosure includes, for example, those realized using at least one processor or circuit configured to function of the embodiments explained above. Note that distributed processing may be performed using a plurality of processors.

This application claims the benefit of priority from Japanese Patent Application No. 2023-003146, filed on Jan. 12, 2023, which is hereby incorporated by reference herein in its entirety.

What is claimed is:

1. An image processing apparatus comprising:
at least one processor; and
a memory coupled to the at least one processor, the memory storing instructions that, when executed by the at least one processor, cause the at least one processor to
detect a shift of black balance in an input image,
acquire at least one of information regarding white balance to be applied to the input image or information regarding static black balance,
calculate a correction value for correcting the shift of the black balance based on at least one of the information regarding the white balance or the information regarding the static black balance in a case in which the shift of the black balance is detected, and
adjust the shift of the black balance in accordance with the calculated correction value.

2. The image processing apparatus according to claim 1, wherein the information regarding white balance includes at least one of a shift of the white balance, a correction amount of the white balance, and a white balance gain.

3. The image processing apparatus according to claim 1, wherein the instructions further cause the at least one processor to determine whether there is an influence of infrared light on the input image, and
the correction value is calculated based on whether there is an influence of infrared light on the input image in a case in which the shift of the black balance is detected.

4. The image processing apparatus according to claim 1, wherein the instructions cause the at least one processor to acquire information regarding an imaging environment of the input image, and
the correction value is calculated based on the information regarding the imaging environment in a case in which the shift of the black balance is detected.

5. The image processing apparatus according to claim 4, wherein the information regarding the imaging environment includes a color temperature of a light source in the imaging environment.

6. The image processing apparatus according to claim 4, wherein the information regarding the imaging environment includes an amount of infrared light in the imaging environment.

7. The image processing apparatus according to claim 1, wherein the instructions further cause the at least one processor to perform control to shift white balance of an image in accordance with information regarding the white balance.

8. The image processing apparatus according to claim 7, wherein the white balance is controlled based on the shift of the black balance.

9. The image processing apparatus according to claim 1, wherein the shift of the black balance is detected by detecting at least one of a signal for each color output from a sensor, which captures the input image, in a case in which the sensor is shielded from light, or a sensor gain, a shutter speed, and an iris aperture value in a case in which the input image is captured, a temperature of an imaging device that captures the input image, an operating time of the imaging device, a temperature in an imaging environment, an illuminance in the imaging environment, and an amount of infrared light in the imaging environment.

10. The image processing apparatus according to claim 9, wherein a larger shift of the black balance is detected as a sensor gain when capturing the input image increases, as the shutter speed decreases, as the iris aperture value becomes closer to an open value, as the temperature of the imaging device capturing the input image increases, as the operating time of the imaging device increases, as the temperature in the imaging environment increases, as the illuminance in the imaging environment decreases, or as the amount of infrared light in the imaging environment increases.

11. The image processing apparatus according to claim 1, wherein the instructions cause the at least one processor to set a priority of a gradation value, and
the correction value is calculated in accordance with the priority of the gradation value.

12. The image processing apparatus according to claim 1, wherein the information regarding the static black balance is information detected at a timing different from a timing at which the shift of the black balance is detected.

13. The image processing apparatus according to claim 12, wherein the information regarding the static black balance includes information regarding at least one of a shift of the static black balance detected at the different timing and temperature information at the different timing.

14. The image processing apparatus according to claim 13, wherein the correction value is calculated in accordance with the temperature information and the shift of the static black balance which are detected at the different timing.

15. The image processing apparatus according to claim 12, wherein the different timing is at least one of a timing at which a user performs calibration, a timing at which an imaging device capturing the input image is started up, a predetermined time, or a timing at which the imaging device is adjusted during manufacturing.

16. The image processing apparatus according to claim 1, wherein the correction value for correcting the shift of the black balance is calculated in accordance with the type of sensor that captures the input image.

17. An image processing method comprising:
detecting a shift of black balance in an input image;
acquiring at least one of information regarding white balance to be applied to the input image or information regarding static black balance;
calculating a correction value for correcting the shift of the black balance based on at least one of the information regarding the white balance or the information regarding the static black balance in a case in which the shift of the black balance is detected in the detecting of the shift of the black balance; and
adjusting the shift of the black balance in accordance with the correction value calculated in the calculating of the correction value.

18. The image processing method according to claim 17, further comprising:
determining whether there is an influence of infrared light on the input image,
wherein the calculating of the correction value includes calculating the correction value based on whether there is an influence of infrared light on the input image in a case in which the shift of the black balance is detected in the detecting of the shift of the black balance.

19. The image processing method according to claim 17, wherein the acquiring of the at least one of information includes acquiring information regarding an imaging environment of the input image, and
the calculating of the correction value includes calculating the correction value based on the information regarding the imaging environment in a case in which the shift of the black balance is detected in the detecting of the shift of the black balance.

20. A non-transitory computer-readable storage medium configured to store a computer program comprising instructions for executing following processes:
detecting a shift of black balance in an input image;
acquiring at least one of information regarding white balance to be applied to the input image or information regarding static black balance;
calculating a correction value for correcting the shift of the black balance based on at least one of the information regarding the white balance or the information regarding the static black balance in a case in which the shift of the black balance is detected in the detecting of the shift of the black balance; and
adjusting the shift of the black balance in accordance with the correction value calculated in the calculating of the correction value.
